(19) United States
(12) Patent Application Publication
(10) Pub. No.: US 2026/0276692 A1
(43) Pub. Date: Sep. 17, 2026

(54) BUSHING DIAGNOSTIC SYSTEM

(71) Applicant: Samsung Electronics Co., Ltd., Suwon-si (KR)

(72) Inventors: Sung Seung LIM, Suwon-si (KR); Yoo Dong YANG, Suwon-si (KR); Jong Hyun LEE, Suwon-si (KR); Jung-Sub SHIN, Suwon-si (KR); Hae Chul KIM, Suwon-si (KR)

(21) Appl. No.: 19/451,483

(22) Filed: Jan. 16, 2026

(30) Foreign Application Priority Data
Mar. 14, 2025 (KR) 10-2025-0033434

(51) Int. Cl. G01R 31/12

(52) U.S. Cl. CPC G01R 31/1272

(57) ABSTRACT

A bushing diagnostic system includes a source chamber that receives a process gas to generate ions, and to discharge the generated ions through an outlet of the source chamber, a power supply for providing a voltage to the source chamber, an extraction chamber surrounding the outlet of the source chamber; a bushing surrounding the source chamber and positioned adjacent to the extraction chamber, the bushing formed of an insulating material, a ground line electrically connected to the bushing, a sensor installed on the ground line and measuring a current flowing from the bushing and through the ground line, and a diagnostic device in communication with the sensor and analyzing a partial discharge type based on the current measured by the sensor. The diagnostic device determines whether the bushing is abnormal based on the analyzed partial discharge type.

### CROSS-REFERENCE TO RELATED APPLICATION

This application claims priority from Korean Patent Application No. 10-2025-0033434 filed on Mar. 14, 2025 in the Korean Intellectual Property Office, and all the benefits accruing therefrom under 35 U.S.C. 119, the contents of which in its entirety are herein incorporated by reference.

### FIELD

The present disclosure relates to a bushing diagnostic system. More specifically, the present disclosure relates to a system for diagnosing a state of a bushing installed in an ion generation apparatus generating ions using a high voltage direct current power source.

### BACKGROUND

An ion implantation facility used for implanting ions into a semiconductor wafer includes an ion implantation apparatus that generates ions. The ion implantation apparatus typically includes a source chamber receiving a process gas and a high voltage to generate ions, and a bushing surrounding the source chamber.

The bushing prevents the voltage provided to the source chamber from leaking to the outside. Accordingly, the voltage applied to the source chamber may maintain a high voltage. To this end, the bushing includes an insulating material having excellent withstand voltage characteristics, such as ceramic.

In the source chamber, by-products may be generated together with ions. The by-products may be discharged from the source chamber and accumulated on a surface of the bushing. The by-products accumulated on the bushing surface degrade the withstand voltage characteristics of the bushing and cause partial discharge of the bushing. The degradation of the withstand voltage characteristic of the bushing destabilizes the voltage applied to the source chamber, and degrades the quality of the generated ions, thereby causing a defect in the ion implantation process. The partial discharge of the bushing may cause arcing to damage the ion implantation facility. Therefore, the bushing is periodically replaced to improve the precision of the process and prevent damage to the facility. However, depending on the initial performance of the bushing or the process frequency, an abnormality in the bushing may occur even when a replacement period does not elapse.

### SUMMARY

A purpose of the present disclosure is to provide a bushing diagnostic system capable of diagnosing a state of a bushing and, upon determination that an abnormality occurs in the bushing, replacing the bushing in a timely manner to improve the quality stability of the ion implantation process and preventing damage to an ion implantation facility.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims and combinations thereof.

According to an aspect of the present disclosure, a bushing diagnostic system comprises a source chamber configured to receive a process gas to generate ions, and to discharge the generated ions through an outlet of the source chamber; a power supply for providing a voltage to the source chamber; an extraction chamber surrounding the outlet of the source chamber; a bushing surrounding the source chamber and positioned adjacent to the extraction chamber, the bushing formed of an insulating material; a ground line electrically connected to the bushing; a sensor installed on the ground line and configured to measure a current flowing from the bushing and through the ground line; and a diagnostic device in communication with the sensor and configured to analyze a partial discharge type based on the current measured by the sensor, the diagnostic device configured to determine whether the bushing is abnormal based on the analyzed partial discharge type.

According to an aspect of the present disclosure, a bushing diagnostic system comprises a source chamber configured to receive a process gas to generate ions, and to discharge the generated ions through an outlet thereof; a power supply for providing a voltage to the source chamber; an extraction chamber surrounding the outlet of the source chamber; a first flange connected to the source chamber; a second flange connected to the extraction chamber; a bushing positioned between the first flange and the second flange, the bushing surrounding the source chamber and formed of an insulating material; a ground line connected to the second flange; a sensor installed on the ground line and configured to measure a current flowing from the bushing and through the ground line a diagnostic device in communication with the sensor and configured to convert a current measured by the sensor into time series data of a charge amount, the diagnostic device configured to analyze the time series data of the charge amount, and determine whether the bushing is abnormal based on the analysis.

According to an aspect of the present disclosure, a bushing diagnostic system comprises an ion generating apparatus including a source chamber configured to generate ions and discharge the ions through an outlet of the source chamber; a power supply configured to provide a voltage to the source chamber; an extraction chamber surrounding the outlet of the source chamber; a bushing surrounding the source chamber and positioned adjacent to the extraction chamber, the bushing formed of an insulating material; a ground line electrically connected to the bushing; and a sensor installed on the ground line and configured to measure a current flowing from the bushing and through the ground line; a process chamber in which a wafer is positioned, wherein the ions discharged from the ion generating apparatus are configured to be injected into the wafer; a beam line installed between the ion generating apparatus and the process chamber, wherein the beam line is configured to receive the ions from the ion generating apparatus, adjust the ions, and provide the adjusted ions to the process chamber; and a diagnostic device configured to analyze a partial discharge type of the bushing based on a current measured by the sensor, the diagnostic device configured to determine whether the bushing is abnormal based on the analyzed partial discharge type being classified as a surface discharge.

Specific details of other embodiments are included in the detailed description and drawings.

It should be noted that the effects of the present disclosure are not limited to those described above, and other effects of the present disclosure will be apparent from the following description.

### BRIEF DESCRIPTION OF DRAWINGS

The above and other aspects and features of the present disclosure will become more apparent by describing in detail illustrative embodiments thereof with reference to the attached drawings, in which:

FIG. 1 is a diagram schematically illustrating a bushing diagnostic system according to some embodiments.

FIG. 2 is a diagram for illustrating the bushing diagnostic system of FIG. 1 in more detail.

FIG. 3 is a plan view for illustrating a bushing of FIG. 1.

FIG. 4 is a cross-sectional view illustrating the bushing of FIG. 1.

FIG. 5 is a view for illustrating an ion implantation facility according to some embodiments.

FIG. 6 is a perspective view for illustrating a surface resistance measuring device according to some embodiments.

FIG. 6 is a cross-sectional view for illustrating a surface resistance measuring device according to some embodiments.

FIG. 8 is a flowchart illustrating a bushing diagnosis method according to some embodiments.

FIG. 9 is a flowchart illustrating the first analysis method in operation S400 of FIG. 8.

FIG. 10 is a diagram for illustrating the first analysis method of FIG. 9.

FIG. 11 is a flowchart illustrating the second analysis method in operation S400 of FIG. 8.

FIGS. 12 and 13 are diagrams for illustrating the second analysis method of FIG. 11.

FIG. 14 is a flowchart illustrating a bushing diagnosis method according to some embodiments.

FIG. 15 is a diagram illustrating the bushing diagnosis method of FIG. 14.

### DETAILED DESCRIPTIONS

Throughout the specification, when a component is described as “including” a particular element or group of elements, it is to be understood that the component is formed of only the element or the group of elements, or the element or group of elements may be combined with additional elements to form the component, unless the context clearly and/or explicitly describes the contrary.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

As used herein, components described as being “electrically connected” are configured such that an electrical signal can be transferred from one component to the other (although such electrical signal may be attenuated in strength as it is transferred and may be selectively transferred).

It will be understood that when an element is referred to as being “connected” or “coupled” to or “on” another element, it can be directly connected or coupled to or on the other element or intervening elements may be present. In contrast, when an element is referred to as being “directly connected,” “directly attached,” “directly joined,” or “directly coupled” to another element, or as “contacting” or “in contact with” another element (or using any form of the word “contact”), there are no intervening elements present at the point of contact.

Hereinafter, embodiments according to the technical idea of the present disclosure will be described with reference to the accompanying drawings.

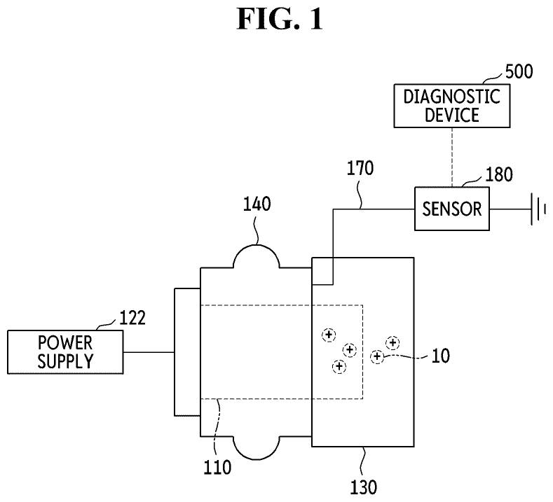

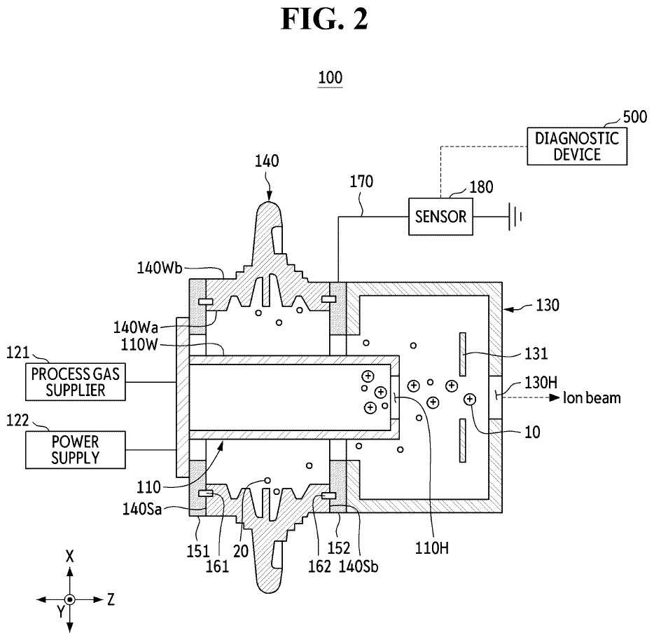

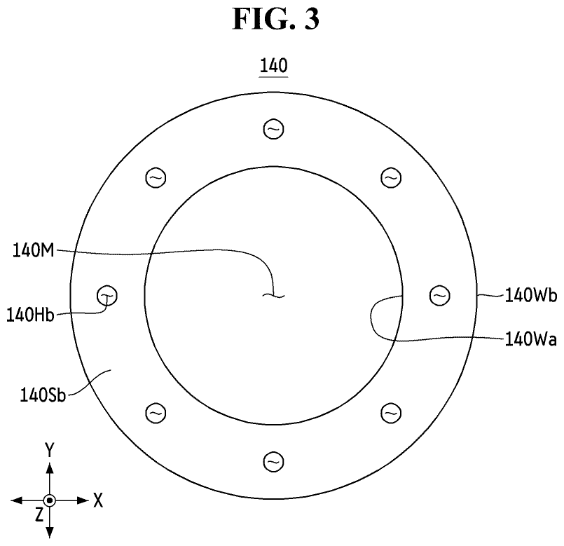

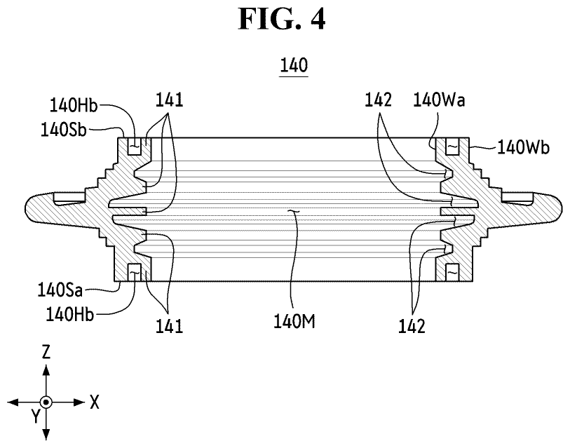

FIG. 1 is a diagram schematically illustrating a bushing diagnostic system according to some embodiments. FIG. 2 is a diagram for illustrating the bushing diagnostic system of FIG. 1 in more detail. FIG. 3 is a plan view for illustrating a bushing of FIG. 1. FIG. 4 is a cross-sectional view illustrating the bushing of FIG. 1.

Referring to FIGS. 1 to 4, the bushing diagnostic system according to some embodiments of the present disclosure includes an ion generation apparatus 100 and a diagnostic device 500.

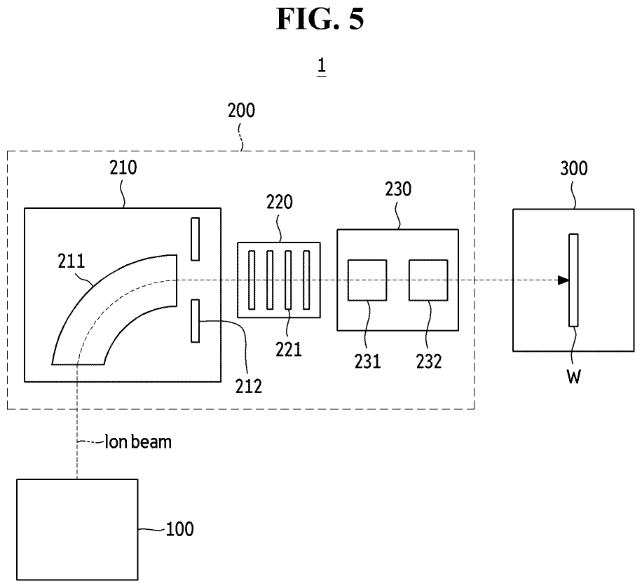

The ion generation apparatus 100 is configured to generate ions 10. The ions 10 may be generated for implantation into a wafer (W in FIG. 5). The ions 10 may be cations. The ions 10 may include, for example, at least one of phosphorus (P), arsenic (AS), boron (B), germanium (Ge), carbon (C), antimony (Sb), and silicon (Si).

The ion generation apparatus 100 may include a source chamber 110, a process gas supplier 121, a power supply 122, an extraction chamber 130, a bushing 140, a first flange 151, a second flange 152, a ground line 170, and a sensor 180.

The source chamber 110 may receive a process gas and a high voltage to generate ions 10. A filament may be installed in the source chamber 110. The filament may include a metal material such as tungsten (W) or copper (Cu). The process gas supplied into the source chamber 110 may collide with electrons emitted from the filament and may be ionized. In a process in which the source chamber 110 generates the ions 10, by-products 20 may be generated together with the ions 10. The by-products 20 may include a conductive material.

The process gas supplier 121 may supply the process gas to the source chamber 110. The process gas may include, for example, at least one of phosphine (PH₃), arsine (AsH₃), boron fluoride (BF₃), germane (GeH₄), methane (CH₄), SbF₅ (antimony pentafluoride), and silane (SiH₄).

The power supply 122 may apply a high voltage to the source chamber 110. For example, the power supply 122 may apply a voltage of 10 kV to 60 kV to the source chamber 110. The power supply 122 may be a high voltage direct current (HVDC) power supply.

The source chamber 110 may discharge the generated ions 10 and by-products 20. The source chamber 110 may include an outlet 110H. The ions 10 and the by-products 20 in the source chamber 110 may be discharged through the outlet 110H.

The source chamber 110 may have a cylindrical shape. However, embodiments of the present disclosure are not limited thereto.

The extraction chamber 130 may surround the source chamber 110. The extraction chamber 130 may surround the outlet 110H of the source chamber 110, such that an interior of the extraction chamber 130 is in fluid communication with an interior of the source chamber 110, and the ions 10 and the by-products 20 can travel from the interior of the source chamber 110, through the outlet 110H, and into the interior of the extraction chamber 130. The extraction chamber 130 may have a cylindrical shape. However, embodiments of the present disclosure are not limited thereto. A diameter of the extraction chamber 130 may be greater than a diameter of the source chamber 110.

The extraction chamber 130 may receive a mixture of the ions 10 and the by-products 20 from the source chamber 110. The extraction chamber 130 may extract the ions 10 from the mixture of the received ions 10 and the by-products 20 and discharge the ions in a form of an ion beam.

The extraction chamber 130 may include an extraction electrode 131 and an outlet 130H. The extraction electrode 131 may be installed in the extraction chamber 130. The extraction electrode 131 may be disposed between the outlet 110H of the source chamber 110 and the outlet 130H of the extraction chamber 130. The outlet 110H of the source chamber 110, the extraction electrode 131, and the outlet 130H of the extraction chamber 130 may be aligned with each other in a first direction Z.

The extraction electrode 131 may receive a negative voltage to attract the ions 10 discharged from the source chamber 110. The ions 10 may be accelerated and aligned with each other by the extraction electrode 131 and discharged in the form of an ion beam through the outlet 130H of the extraction chamber 130.

The bushing 140 may be installed such that the bushing 140 surrounds the source chamber 110 and the bushing 140 is adjacent to the extraction chamber 130. The bushing 140 may be connected to the source chamber 110 and the extraction chamber 130. The bushing 140 may electrically isolate the source chamber 110 from the extraction chamber 130.

The bushing 140 may surround the source chamber 110. The bushing 140 may be spaced apart from the source chamber 110 in a second direction X, such that an inner sidewall 140Wa of the bushing 140 may be spaced a distance apart from an outer surface of the source chamber 110, thus defining a hollow chamber 140M radially between the bushing 140 and the source chamber 110. The second direction X may be orthogonal to the first direction Z. A third direction Y may be orthogonal to the first direction Z and the second direction X. The bushing 140 may insulate a high voltage applied to the source chamber 110 from the outside.

The bushing 140 may include an insulating material having excellent withstand voltage characteristics, such as ceramic. In embodiments, the bushing 140 may have an electrical resistivity within a range from 10¹² to 10¹⁶ ohm-centimeters.

A shape of the bushing 140 will be described in detail with reference to FIGS. 3 and 4. The bushing 140 may have a tubular shape. The bushing 140 may include the hollow chamber 140M. The source chamber 110 may extend through the hollow chamber 140M of the bushing 140.

The bushing 140 may include a plurality of protrusions 141 and a plurality of grooves 142. The plurality of protrusions 141 may protrude in the second direction X toward the hollow 140M of the bushing 140. The plurality of protrusions 141 may be spaced apart from each other in the first direction Z. Each of the plurality of grooves 142 may be disposed between adjacent protrusions 141. The plurality of grooves 142 may be spaced apart from each other in the first direction Z. Accordingly, the inner sidewall 140Wa of the bushing 140 may be spaced a non-uniform distance from a center of the bushing 140, for example, with protrusions 141 located a closer distance to the center of the bushing 140, and grooves 142 located a farther distance from the center of the bushing 140.

The bushing 140 may include the inner sidewall 140Wa and an outer sidewall 140Wb opposite to each other in the second direction X. The inner sidewall 140Wa of the bushing 140 may define the hollow chamber 140M of the bushing 140. The inner sidewall 140Wa of the bushing 140 may face the source chamber 110. The inner sidewall 140Wa of the bushing 140 and the outer sidewall 110W of the source chamber 110 may face each other.

The inner sidewall 140Wa of the bushing 140 may include convex and concave patterns. The inner sidewall 140Wa of the bushing 140 may include convex surfaces and concave surfaces that are alternately arranged with each other. The inner sidewall 140Wa of the bushing 140 may be defined by the protrusions 141 of the bushing 140 and the grooves 142 of the bushing 140.

The bushing 140 may include a first surface 140Sa and a second surface 140Sb opposite to each other in the first direction Z. The second surface 140Sb of the bushing 140 may face the extraction chamber 130. Each of the first surface 140Sa and the second surface 140Sb of the bushing 140 may connect the inner sidewall 140Wa and the outer sidewall 140Wb of the bushing 140 to each other. In embodiments, the first surface 140Sa and the second surface 140Sb may be parallel to one another, with the first surface 140Sa forming a first end of the bushing 140, and the second surface 140Sb forming an opposing second end of the bushing 140.

The first flange 151 may be disposed adjacent to, and in contact with, the first surface 140Sa of the bushing 140. The second flange 152 may be disposed adjacent to, and in contact with, the second surface 140Sb of the bushing 140. The bushing 140 may be disposed between the first flange 151 and the second flange 152. The first flange 151 and the second flange 152 may be spaced apart from each other in the first direction Z. Each of the first flange 151 and the second flange 152 may include a conductive material such as aluminum (Al).

The first flange 151 is installed between the source chamber 110 and the bushing 140. The first flange 151 provides a physical connection between the source chamber 110 and the bushing 140. The source chamber 110 and the bushing 140 may be fixedly coupled to each other via the first flange 151, for example, with a first portion of the first flange 151 attached to the source chamber 110, and a second portion of the first flange 151 attached to the bushing 140.

The second flange 152 is installed between the extraction chamber 130 and the bushing 140. The second flange 152 provides a physical connection between the extraction chamber 130 and the bushing 140. The extraction chamber 130 and the bushing 140 may be fixedly coupled to each other via the second flange 152, for example, with a first portion of the second flange 152 attached to the extraction chamber 130, and a second portion of the second flange 152 attached to the bushing 140.

The bushing 140 may be constructed to be mounted onto and detached from the ion generating apparatus 100. The bushing 140 may be coupled to each of the first flange 151 and the second flange 152 with one or more mechanical fastening members, such as screws, bolts, etc.

A first fastening member 161 may connect the bushing 140 and the first flange 151 to each other. The bushing 140 may include a plurality of first connection holes 140Ha formed in the first surface 140Sa. The first fastening member 161 may be inserted into the first connection hole 140Ha of the bushing 140.

A second fastening member 162 may connect the bushing 140 and the second flange 152 to each other. The bushing 140 may include a plurality of second connection holes 140Hb formed in the second surface 140Sb. The second fastening member 162 may be inserted into the second connection hole 140Hb of the bushing 140.

Each of the first fastening member 161 and the second fastening member 162 may include a bolt and a nut. Each of the first fastening member 161 and the second fastening member 162 may include a conductive material.

The ground line 170 may be connected to the second flange 152. Unlike the illustrated case, in other embodiments, the ground line 170 may be directly connected to the bushing 140. The ground line 170 may be formed of an electrically conductive material, and the ground line 170 may discharge a current flowing in the second flange 152 to an exterior of the ion generation apparatus 100. When a current flows in the bushing 140, the ground line 170 may discharge the current flowing in the bushing 140 to the outside. The ground line 170 may be connected to an external grounding device that provides a grounding function.

The sensor 180 may be installed on the ground line 170 and may be electrically connected to the ground line 170. The sensor 180 may measure a current flowing through the ground line 170. When a current flows in the bushing 140, the sensor 180 may measure the current flowing in the bushing 140 (e.g., via the current being discharged by the ground line 170). The sensor 180 may be, for example, a high frequency current transformer (HFCT) sensor.

The diagnostic device 500 may determine whether the bushing 140 is abnormal based on the current data measured by the sensor 180. The diagnostic device 500 may receive current data from the sensor 180. The diagnostic device 500 may collect the received current data. The diagnostic device 500 may convert the current data measured by the sensor 180 into time series data of a charge amount. The diagnostic device 500 may analyze a partial discharge type based on the time series data of the converted charge amount. The diagnostic device 500 may determine whether the bushing 140 is abnormal based on the analyzed partial discharge type.

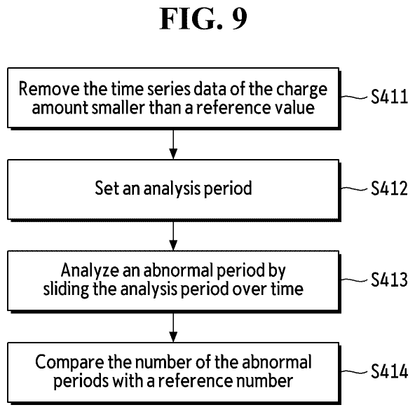

When the analyzed partial discharge type is surface discharge, the diagnostic device 500 determines that the bushing 140 is abnormal. A method for analyzing the partial discharge type based on the time series data of the charge amount as converted by the diagnostic device 500 will be described later with reference to FIGS. 9-13.

The diagnostic device 500 may include a computer capable of collecting, converting, and analyzing data and a monitor capable of visualizing and displaying the analyzed data. The diagnostic device 500 may be a computer (or several interconnected computers) and may include, for example, one or more processors configured by software, such as a CPU (Central Processing Unit), GPU (graphics processor), controller, etc. that form various functional modules of the computer. The computer may be a general purpose computer or may be dedicated hardware or firmware (e.g., an electronic or optical circuit, such as application-specific hardware, such as, for example, a digital signal processor (DSP) or a field-programmable gate array (FPGA)). A computer may be configured from several interconnected computers. Each functional module (or unit) described herein may comprise a separate computer, or some or all of the functional module (or unit) may be comprised of and share the hardware of the same computer. Connections and interactions between the units described herein may be hardwired and/or in the form of data (e.g., as data stored in and retrieved from memory of the computer, such as a register, buffer, cache, storage drive, etc., such as part of an application programming interface (API)). The functional modules (or units) of the control unit may each correspond to a separate segment or segments of software (e.g., a subroutine) which configure the computer of the diagnostic device 500, and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script. The diagnostic device 500 may comprise storage that may comprise conventional memory of a computer, such as a hard drive (which may be a solid state drive, DRAM, NAND flash memory, etc.). The diagnostic device 500 may comprise a conventional computer user interface and include convention input devices, such as a keyboard, mouse, trackpad, touchscreen, etc.

The source chamber 110 generates and discharges the ions 10 and by-products 20. Unlike the ions 10, the by-products 20 discharged from the source chamber 110 may not be attracted by the extraction electrode 131. Accordingly, the by-product 20 may not be discharged from the extraction chamber 130 and may remain in the extraction chamber 130. The by-product 20 remaining in the extraction chamber 130 may move to a space between the source chamber 110 and the bushing 140 and may accumulate on the inner sidewall 140Wa of the bushing 140. The by-products 20 accumulated on the inner sidewall 140Wa of the bushing 140 may degrade the insulating ability of the bushing 140. Thus, to maintain the performance of the bushing 140, the bushing 140 is periodically replaced.

However, depending on an initial performance difference of the bushing 140 or a process frequency, even before a time reaches a replacement period of the bushing 140, an abnormality in the bushing 140 may occur. When the ion generation apparatus 100 generates the ions 10 despite the abnormality in the bushing 140, the quality of the generated ions 10 may be deteriorated and the ion generation apparatus 100 may be damaged by arcing.

The bushing diagnostic system according to some embodiments of the present disclosure includes the ground line 170 connected to the bushing 140, the sensor 170 for measuring a current flowing through the ground line 170, and the diagnostic device 500 for determining whether the bushing 140 is abnormal based on the current data measured by the sensor 170. The bushing diagnostic system according to the present disclosure may determine whether the bushing 140 is abnormal using the sensor 170 and the diagnostic device 500. When an abnormality occurs in the bushing 140, the bushing 140 may be replaced even when the time has not reached the replacement period of the bushing 140. Monitoring whether an abnormality occurs in the bushing 140 in real time and replacing the bushing 140 regardless of the replacement period upon determination that the abnormality occurs may allow the quality stability of the ions 10 to be improved. In addition, replacing the bushing 140 may reduce the likelihood of an abnormal bushing causing damage to the ion generating apparatus 100.

FIG. 5 is a view for illustrating an ion implantation facility according to some embodiments. Referring to FIG. 5, the ion implantation facility 1 according to some embodiments may be a facility that performs an ion implantation process during a semiconductor manufacturing process. The ion implantation facility 1 may include the ion generation apparatus 100, a beam line 200, and a process chamber 300.

The ion generating apparatus 100 has been described above with reference to FIGS. 1-4, and thus a detailed description thereof will be omitted. The ion generation apparatus 100 generates the ions (10 in FIG. 2) and discharges the ions in the form of an ion beam.

The beam line 200 may adjust the ions 10 discharged from the ion generating apparatus 100 and direct the adjusted ions to the process chamber 300. The beam line 200 may select and accelerate the ions 10 and adjust a shape and direction of the ion beam. The beam line 200 may include an ion selector 210, an ion accelerator 220, and a beam adjuster 230.

The ion selector 210 may select the ions 10 provided from the ion generating apparatus 100 and provide the selected ions to the process chamber 300. The ion selector 210 may select the ions 10 to be provided to the process chamber 300 using a mass difference of the ions 10. The ion selector 210 includes a mass analyzer 211 and a slit 212.

The mass analyzer 211 may select ions 10 having a desired mass using a magnetic field. The slit 212 may be disposed at an end of the mass analyzer 211. The ion 10 selected by the mass analyzer 211 may flow through the slit 212 and be provided to the ion accelerator 220.

The mass analyzer 211 includes an analyzer magnet. The analyzer magnet may have a bending angle of, for example, 90°. The magnetic field of the analyzer magnet provides a force that deflects a movement path of the ion beam into a curved trajectory. The movement of the ions 10 having a relatively heavy mass has a smaller bending angle than that of the movement of the ions 10 having a relatively light mass. The mass analyzer 211 may allow only the ions 10 having the desired mass to reach the slit 212 located at the end of the mass analyzer 211 by adjusting the magnetic field strength of the analyzer magnet.

The ion accelerator 220 may accelerate or decelerate the ions 10 selected by the ion selector 210. The ion accelerator 220 may accelerate or decelerate the ions 10 to adjust an implantation depth of the ions 10 implanted into the wafer W. The ion accelerator 220 may include an acceleration electrode 221. The acceleration electrode 221 may have a ring shape. When a negative voltage is applied to the acceleration electrode 221, the ions 10 may be accelerated. When a positive voltage is applied to the acceleration electrode 221, the ions 10 may be decelerated.

The beam adjuster 230 may adjust the shape and direction of the ion beam that has flowed through the ion accelerator 220. The beam adjuster 230 may include a lens 231 and a scanner 232. The lens 231 may adjust the focus and shape of the ion beam. The lens 231 may include a quadrupole magnet. The scanner 232 may deflect the ion beam using an electric field.

The process chamber 300 may be constructed to perform an ion implantation process on the wafer W. The wafer W may be supported on a wafer handler (not shown) and placed in the process chamber 300 in the supported state. The ion beam generated by the ion generating apparatus 100 may flow through the beam line 200 and be injected into the wafer W disposed in the process chamber 300.

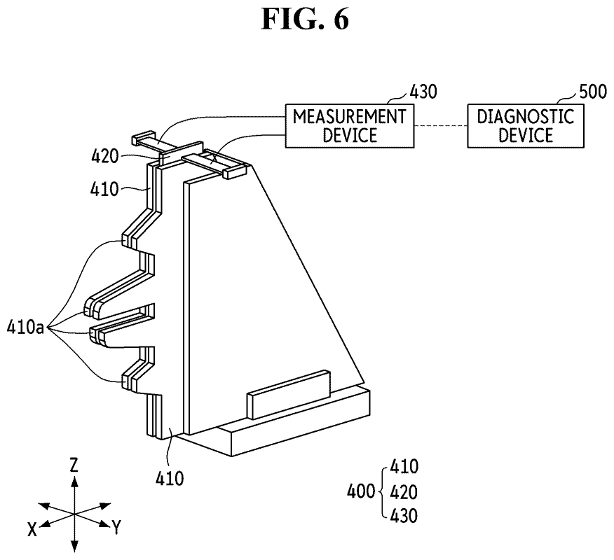

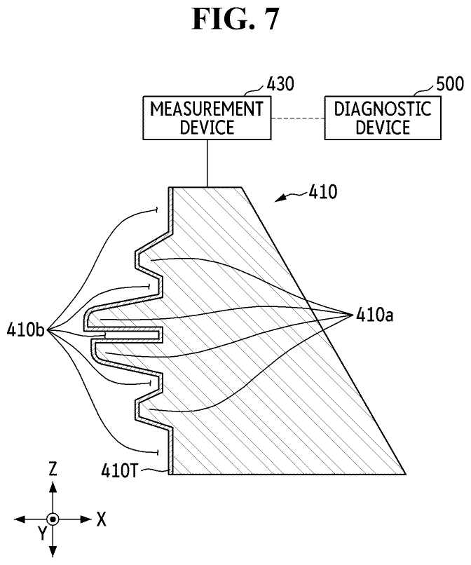

FIG. 6 is a perspective view for illustrating a surface resistance measuring device according to some embodiments.

A surface resistance measuring device 400 may be configured to measure the surface resistance of the inner sidewall 140Wa of the bushing 140 (see FIG. 2). The surface resistance measuring device 400 may include a plurality of probes 410, a frame 420, and a measuring device 430. In embodiments, the surface resistance measuring device 400 may be used to measure the surface resistance of the inner sidewall 140Wa prior to installation of the bushing 140 within the ion generation apparatus 100 (e.g., between the flanges 151, 152). The surface resistance measuring device 400 may be used to ensure that the surface resistance of the bushing 140 is within an intended range prior to installation of the bushing 140.

The plurality of probes 410 may be in contact with the inner sidewall 140Wa of the bushing 140. The plurality of probes 410 may be spaced apart from each other. The frame 420 may be disposed between the plurality of probes 410. The frame 420 may electrically isolate the plurality of probes 410 from each other.

A contact surface of each of the plurality of probes 410 may be a surface in contact with the inner sidewall 140Wa of the bushing 140. The contact surface of each probe 410 may have a shape such that the contact surface is meshed with the inner sidewall 140Wa of the bushing 140. The contact surface of each probe 410 may include convex-concave patterns. The contact surface of each probe 410 may include convex surfaces and concave surfaces alternately arranged with each other. In embodiments, the shape, size, and position of the probes 410 may match the shape, size, and position of the grooves 142 of the bushing 140, allowing the measuring device 400 to engage with the bushing 140.

Each probe 410 may include a plurality of protrusions 410a and a plurality of grooves 410b. The protrusion 410a and the groove 410b of the probe 410 may define the contact surface of the probe 410. The plurality of protrusions 410a may be spaced apart from each other. The protrusion 410a of the probe 410 may have a shape so as to be engaged with the groove 142 of the bushing 140. Each of the plurality of grooves 410b may be disposed between adjacent protrusions 410a. The groove 410b of the probe 410 may have a shape so as to be engaged with the protrusion 141 of the bushing 140.

As the protrusion 410a of the probe 410 has a shape so as to be engaged with the groove 142 of the bushing 140, the probe 410 may be in contact with the inner sidewall 140Wa of the groove 142 of the bushing 140. Accordingly, the surface resistance measuring device 400 may measure the surface resistance of the inner sidewall 140Wa of the groove 142 of the bushing 140. Accordingly, the surface resistance measuring device 400 may precisely measure the surface resistance of the inner sidewall 140Wa of the bushing 140.

The probe 410 may further include a tape 410T attached to the contact surface of the probe 410. The tape 410T may extend along and on the contact surface of the probe 410. The tape 410T may include a conductive material. The tape 410T may be an electric conductive tape (ECT). As the tape 410T is attached to the contact surface of the probe 410, the probe 410 may be in closer contact with the inner sidewall 140Wa of the bushing 140.

The measuring device 430 may measure the surface resistance using the plurality of probes 410. The measuring device 430 may be connected to each of the plurality of probes 410. The measuring device 430 may be configured to apply a current to the bushing 140 using the plurality of probes 410 and to measure a voltage generated as the current is applied to the bushing 140 and to measure the surface resistance of the inner sidewall 140Wa of the bushing 140 based on the measurement result.

The diagnostic device 500 may receive the surface resistance data of the inner sidewall 140Wa of the bushing 140 as measured by the surface resistance measuring device 400. The diagnostic device 500 may determine whether the bushing 140 is abnormal based on the received surface resistance data.

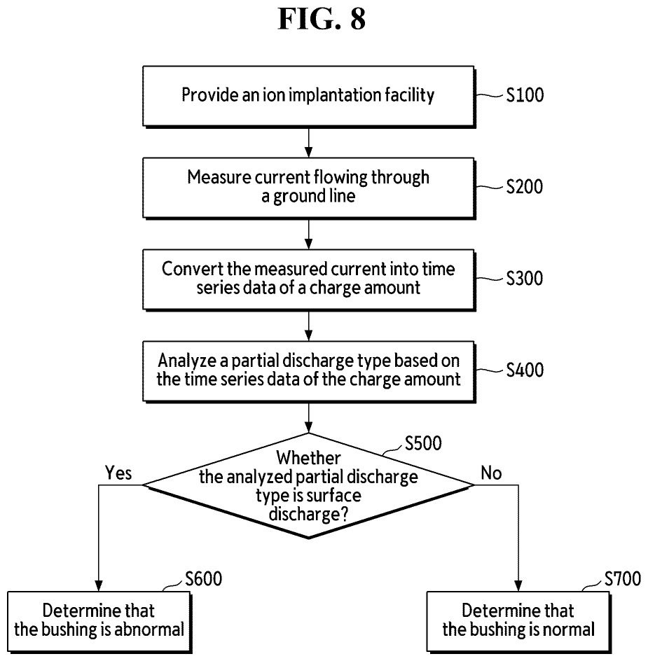

FIG. 8 is a flowchart illustrating a bushing diagnosis method according to some embodiments. For convenience of description, contents duplicate with those described above using FIGS. 1 to 7 will be briefly described or the descriptions thereof will be omitted.

Referring to FIG. 8, the ion implantation facility is provided in S100.

The ion implantation facility 1 may include the ion generation apparatus 100, the beam line 200, the process chamber 300, and other structures, components, etc. illustrated in FIG. 5. The ion generation apparatus 100 may include the source chamber 110, the process gas supplier 121, the power supplier 122, the extraction chamber 130, the bushing 140, the first flange 151, the second flange 152, the ground line 170, the sensor 180, and other structures, components, etc. illustrated in FIGS. 1-4.

Subsequently, a current flowing through the ground line 170 is measured (e.g., by the sensor 180) in S200.

The power supply 122 applies a high voltage to the source chamber 110. The sensor 180 measures a current flowing through the ground line 170. When a current flows in the bushing 140, the current flowing in the bushing 140 may be discharged to the ground line 170.

Subsequently, the measured current is converted into time series data of the charge amount in S300. For example, the diagnostic device 500 may convert the current data measured by the sensor 180 into time series data of the charge amount.

The time series data of the charge amount refers to data obtained by converting the measured current (e.g., by the sensor 180) into the charge amount over time. The time series data of the charge amount may be represented by (t, Q). (t, Q), which means that a charge amount at time t is Q.

Subsequently, the partial discharge type is analyzed based on the time series data of the charge amount in S400.

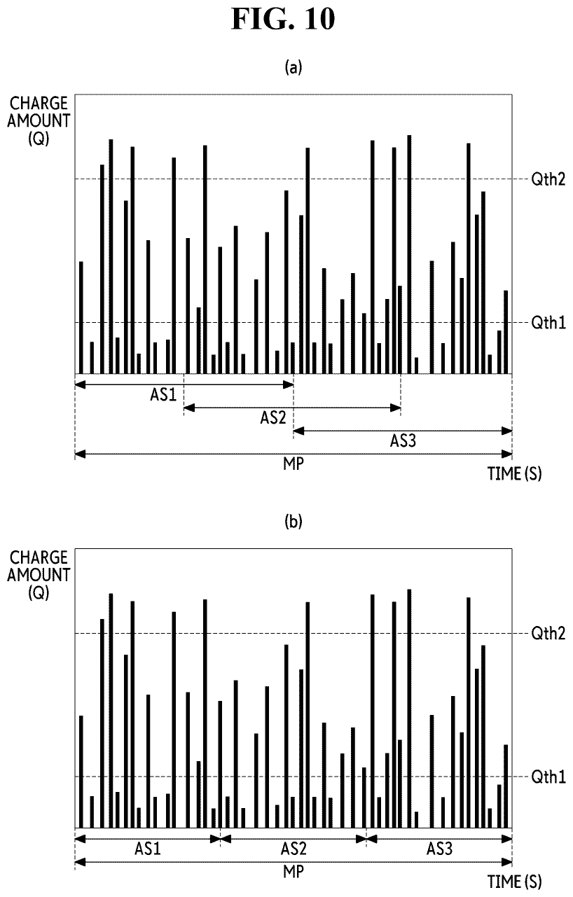

In some embodiments, the bushing diagnosis method may analyze the partial discharge type using a first analysis method. Hereinafter, the first analysis method will be described using FIGS. 9 and 10.

FIG. 9 is a flowchart illustrating the first analysis method in operation S400 of FIG. 8. FIG. 10 is a diagram for illustrating the first analysis method of FIG. 9. For reference, each of (a) and (b) of FIG. 10 is a bar graph showing a magnitude of the charge amount Q over time s.

Referring to FIGS. 9 and 10, the time series data of the charge amount smaller than a reference value is removed in S411.

For precise analysis, preprocessing may be performed on the time series data of the charge amount. Accordingly, the time series data of the charge amount smaller than a first reference value Qth1 may be removed. The time series data of the charge amount smaller than the first reference value Qth1 means data in which the charge amount is lower than the first reference value Qth1 among the time series data of the charge amount.

Subsequently, an analysis period is set in S412.

The analysis period may refer to a time period set to analyze time series data of a charge amount. The analysis period may include a plurality of pieces of charge amount data. A size of the analysis period is smaller than a size of a measurement period of the charge amount. In embodiments, the measurement period may comprise a plurality of analysis periods, for example, a first analysis period, a second analysis period, a third analysis period, etc.

Subsequently, an abnormal period is analyzed by sliding the analysis period over time in S413. In embodiments, sliding the analysis period may comprise setting a plurality of analysis periods within the measurement period, and analyzing each of the analysis periods.

The analysis period may be shifted over time within the measurement period of the charge amount. Since the size of the analysis period is smaller than the size of the measurement period, a plurality of analysis periods may exist within the measurement period of the charge amount. For example, as illustrated in FIG. 10, first to third analysis periods AS1, AS2, and AS3 may exist within the measurement period MP of the charge amount. The first to third analysis periods AS1, AS2, and AS3 may be continuous analysis periods. The continuous analysis periods mean that there is no other analysis period between the analysis periods. For example, the analysis periods may overlap with one another (e.g., as illustrated in FIG. 10(a)), or one analysis period may end at the same time that a second analysis period begins (e.g., as illustrated in FIG. 10(b)).

In some embodiments, a plurality of analysis periods in the measurement period of the charge amount may partially overlap each other. One piece of charge amount data may be included in the plurality of analysis periods. For example, a piece of charge amount data may be included in both the first analysis period AS1 and the second analysis period AS2.

For example, referring to (a) in FIG. 10, a portion of the second analysis period AS2 overlaps the first analysis period AS1. The second analysis period AS2 includes a portion of the charge amount data included in the first analysis period AS1. In addition, a portion of the third analysis period AS3 overlaps the second analysis period AS2. The third analysis period AS3 includes a portion of the charge amount data included in the second analysis period AS2.

As illustrated in (a) of FIG. 10, the third analysis period AS3 does not overlap the first analysis period AS1. However, this is only for convenience of illustration, and the present disclosure is not limited thereto. Unlike the illustrated example, a portion of the third analysis period AS3 may overlap the first analysis period AS1. The third analysis period AS3 may include a portion of the charge amount data included in the first analysis period AS1. As illustrated in (a), when the first analysis period AS1 ends, the third analysis period AS3 may begin, and the second analysis period AS2 may overlap both the first analysis period AS1 and the third analysis period AS3.

In some embodiments, the plurality of analysis periods within the measurement period of the charge amount may not overlap each other. The analysis periods include different charge amount data.

For example, referring to (b) in FIG. 10, the second analysis period AS2 does not overlap the first analysis period AS1. Rather, when the first analysis period AS1 ends, the second analysis period AS2 begins. The third analysis period AS3 does not overlap the second analysis period AS2. Rather, when the second analysis period AS2 ends, the third analysis period AS3 begins. The charge amount data included in the first analysis period AS1 is not included in the second analysis period AS2 and vice versa. The charge amount data included in the second analysis period AS2 is not included in the third analysis period AS3 and vice versa.

Analyzing an abnormal period may include detecting the abnormal period and counting the number of detected abnormal periods. The abnormal period may refer to an analysis period for which the number of charge amount data exceeding a second reference value Qth2 is equal to or greater than a first reference number. The second reference value Qth2 is greater than the first reference value Qth1. The second reference value Qth2 may be a threshold value for the charge amount data.

For example, the first reference number may be 5. In this case, referring to (a) in FIG. 10, the first analysis period AS1 includes five pieces of charge amount data exceeding the second reference value Qth2. Thus, the first analysis period AS1 may be an abnormal period because the first reference number is set to 5, and the first analysis period AS1 comprises five pieces (e.g., instances) of charge amount data that exceed the second reference value Qth2. Since the second analysis period AS2 includes four pieces of charge amount data exceeding the second reference value Qth2, the second analysis period AS2 may be a normal period (e.g., not an abnormal period) because the second analysis period AS2 comprises fewer than five pieces (e.g., instances) of charge amount data that exceed the second reference value Qth2.

Subsequently, the number of the abnormal periods is compared with a reference number in S414.

Specifically, the number of abnormal periods is compared with a second reference number to analyze the partial discharge type based on the comparison. When the number of abnormal periods is equal to or greater than the second reference number, the partial discharge type is determined to be, or classified as, a surface discharge. The second reference number may be different from the first reference number.

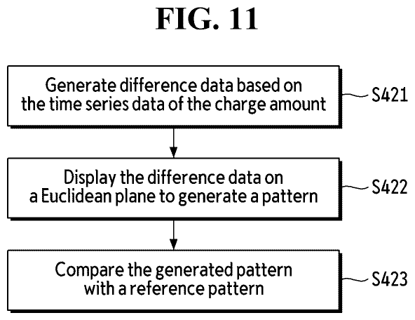

In some embodiments, the bushing diagnosis method may analyze the partial discharge type using a second analysis method. Hereinafter, the second analysis method will be described using FIGS. 11-13.

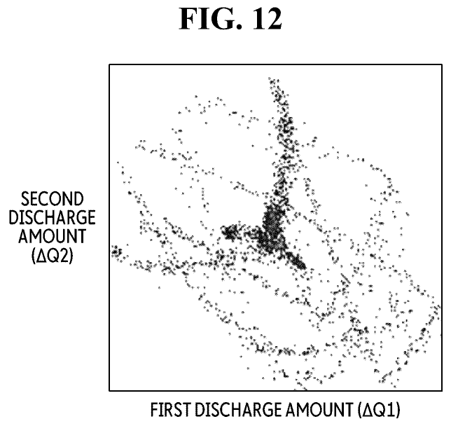

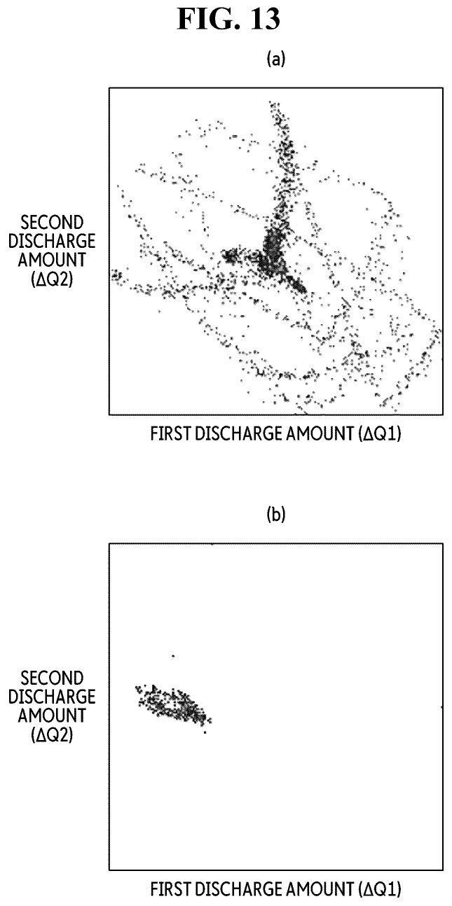

FIG. 11 is a flowchart illustrating the second analysis method in operation S400 of FIG. 8. FIGS. 12 and 13 are diagrams for illustrating the second analysis method of FIG. 11.

Referring to FIG. 11, difference data is generated using a difference between time series data of the charge amount in S421.

The time series data may include a plurality of charge amount data. For example, the time series data of the charge amount may include first charge amount data, second charge amount data, and third charge amount data. The first charge amount data, second charge amount data, and third charge amount data may be consecutively measured charge amount data. The first charge amount data may be represented by (t1, Q1), which means that the charge amount at time t1 is Q1. The second charge amount data may be represented by (t2, Q2), which means that the charge amount at time t2 is Q2. The third charge amount data may be represented by (t3, Q3), which means that the charge amount at time t3 is Q3. Time t1, time t2, and time t3 may be consecutive measurement times. Time t2 may be a time between time t1 and time t3. The charge amount data may be an instantaneous charge amount, for example, the charge amount for one piece/instance. For example, time t1 may refer to one moment in time, such that the charge amount Q1 is the charge amount at that time t1.

The difference data is generated using a difference between time series data of the charge amount. The difference data may be generated by three pieces of consecutively measured charge amount data. The difference data may include a first discharge amount ΔQ1 and a second discharge amount ΔQ2. The difference data may be represented by (ΔQ1, ΔQ2).

The first discharge amount ΔQ1 and the second discharge amount ΔQ2 are calculated by calculating a difference between the charge amounts of the charge amount data adjacent to other in a time series manner. The first discharge amount ΔQ1 may be calculated by a difference of a first two pieces of consecutively measured charge amount data among three pieces of consecutively measured charge amount data. The second discharge amount ΔQ2 may be calculated by a difference of a last two pieces of consecutively measured charge amount data among three pieces of consecutively measured charge amount data.

For example, the first discharge amount ΔQ1 may include a difference between the charge amounts of the first charge amount data (t1, Q1) and the second charge amount data (t2, Q2). The first discharge amount ΔQ1 may include (Q2−Q1). The second discharge amount ΔQ2 may include a difference between the charge amounts of the second charge amount data (t2, Q2) and the third charge amount data (t3, Q3). The second discharge amount ΔQ2 may include (Q3−Q2).

The difference data is generated using the first discharge amount ΔQ1 and the second discharge amount ΔQ2. The difference data may include (Q2−Q1), (Q3−Q2).

Subsequently, the difference data is displayed on the Euclidean plane to generate a pattern in S422.

The displaying of the difference data on the Euclidean plane may include displaying the difference data on a coordinate system having the first discharge amount ΔQ1 as a horizontal axis and the second discharge amount ΔQ2 as a vertical axis. As the plurality of difference data are displayed on the Euclidean plane, a visualized pattern is generated.

Subsequently, the generated pattern is compared with a reference pattern in S423.

First, a method of generating the reference pattern will be described. The reference pattern may be generated by the normal bushing 140. The reference pattern can be generated by performing S421 and S422 based on the time series data of the bushing 140 determined to be normal. The reference pattern may be generated by performing S421 and S422 based on the time series data of the charge amount determined as the surface discharge by the first analysis method described above.

Subsequently, the generated pattern and the reference pattern are compared with each other.

The similarity between the patterns is analyzed based on comparing the result of the generated pattern and the reference pattern. The similarity between the patterns is analyzed by comparing the difference data of the reference pattern and the difference data of the generated pattern using a similarity analysis method. The similarity analysis method includes visual analysis, analysis using mean and variance, or analysis using Euclidean distance.

When it is analyzed that the generated pattern and the reference pattern are similar to each other, the partial discharge type is determined as surface discharge. When the similarity obtained by the similarity analysis method is 70% or greater, it may be determined that the generated pattern and the reference pattern are similar to each other.

Referring to FIGS. 12 and 13, a pattern of FIG. 12 is a diagram illustrating an example reference pattern. Patterns (a) and (b) of FIG. 13 are example generated patterns generated based on time series data of different charge amounts, respectively.

The pattern (a) of FIG. 13 may be a pattern having a similarity of 70% or more with the reference pattern of FIG. 12. The pattern (a) of FIG. 13 may be analyzed to be similar to the reference pattern of FIG. 12. When the pattern (a) is analyzed to be similar to the reference pattern, the partial discharge type is determined as the surface discharge.

The pattern (b) of FIG. 13 may be a pattern having less than 70% similarity with the reference pattern of FIG. 12. The pattern (b) of FIG. 13 may be analyzed and determined to not be similar to the reference pattern of FIG. 12. When the pattern (b) is analyzed and determined to not be similar to the reference pattern, it is determined that the partial discharge type is not surface discharge.

Next, referring to FIG. 8 again, when the analyzed partial discharge type is surface discharge (Yes in S500), it is determined that the bushing is abnormal in S600.

When it is determined that the bushing 140 is abnormal, an operator may replace the bushing 140.

When the analyzed partial discharge type is not surface discharge (No in S500), it is determined that the bushing is normal in S700.

The occurrence of the abnormality in the bushing 140 means that the insulation ability of the bushing 140 has deteriorated. When the insulation ability of the bushing 140 has deteriorated, a partial discharge may occur in the bushing 140. Since the partial discharge of the bushing 140 is due to the process by-products 20 accumulating on the inner sidewall 140Wa of the bushing 140, the partial discharge may appear in a form of the surface discharge. The surface discharge tends to occur continuously within the measurement time duration.

The bushing diagnosis method according to some embodiments of the present disclosure measures the current flowing through the bushing and analyzes whether partial discharge continues to occur based on the measured current. Whether the partial discharge continues to occur may be quantified and analyzed using the first analysis method or the second analysis method.

According to the present disclosure, the system and the method may determine whether the surface discharge of the bushing 140 occurs based on analyzing results of whether the partial discharge continues to occur. When it is determined that the surface discharge of the bushing 140 has occurred, it may be determined that an abnormality has occurred in the bushing 140. When an abnormality occurs in the bushing 140, the bushing 140 may be immediately replaced even when a current time has not reached the replacement period of the bushing 140. Thus, continuously monitoring whether an abnormality occurs in the bushing 140 and replacing the bushing 140 regardless of the replacement period upon determination that the abnormality occurs may allow the quality stability of the ion 10 to be improved, and allow the damage to the bushing 140 and the ion generating apparatus 100 including the same to be prevented.

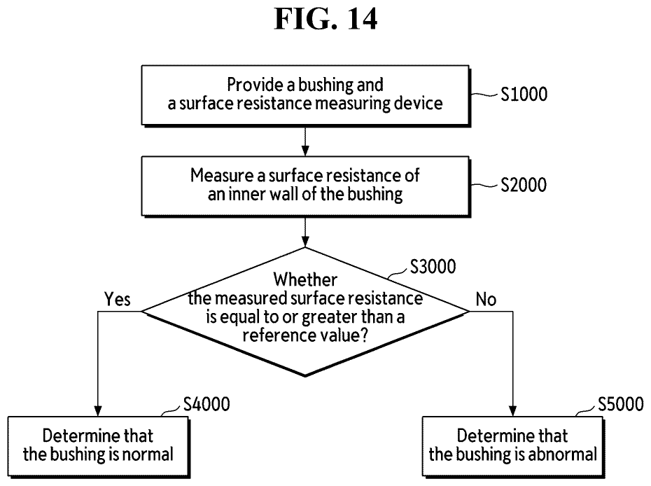

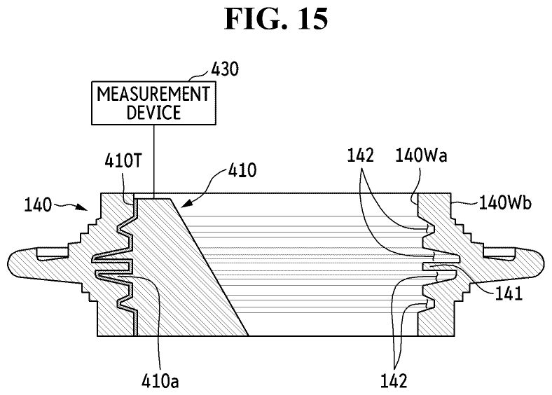

FIG. 14 is a flowchart illustrating a bushing diagnosis method according to some embodiments. FIG. 15 is a diagram illustrating the bushing diagnosis method of FIG. 14. For convenience of description, the contents duplicate with those as described above using FIGS. 1-7 will be briefly described or the descriptions thereof will be omitted.

Referring to FIGS. 14 and 15, the bushing and the surface resistance measuring device are provided in S1000.

The bushing 140 may be provided in a detached state from the ion generation apparatus (100 of FIG. 2). The bushing 140 may be provided in a state in in which the busing is present before being mounted on the ion generating apparatus 100.

Subsequently, the surface resistance of the inner wall of the bushing is measured in S2000.

The surface resistance measuring device 400 measures the surface resistance of the inner sidewall 140Wa of the bushing 140.

Specifically, each of the plurality of probes 410 contact the inner sidewall 140Wa of the bushing 140. The protrusion 410a of the probe 410 is in contact with the groove 142 of the bushing 140. The groove (410b in FIG. 7) of the probe 410 is in contact with the protrusion 141 of the bushing 140.

In some embodiments, the probe 410 may contact the inner sidewall 140Wa of the bushing 140 with the tape 410T attached thereto. The tape 410T contacts the inner sidewall 140Wa of the bushing 140.

The measuring device 430 measures the surface resistance of the inner sidewall 140Wa of the bushing 140 using the probe 410. The measuring device 430 applies a current to the bushing 140 using the plurality of probes 410, measures a voltage generated therefrom by applying the current to the bushing 140, and measures the surface resistance of the inner sidewall 140Wa of the bushing 140.

When the measured surface resistance is equal to or greater than a reference value (Yes in S3000), the bushing is determined to be normal in S4000.

When the surface resistance of the inner sidewall 140Wa of the bushing 140 measured by the surface resistance measuring device 400 is equal to or greater than the reference value, the bushing 140 is determined to be normal. Since the bushing 140 includes an insulating material having excellent withstand voltage characteristics, the surface resistance of the bushing 140 in the normal state may be equal to or greater than the reference value.

When the measured surface resistance is smaller than the reference value (No in S3000), the bushing is determined to be abnormal in S5000.

The bushing 140 is a component that is mounted on the ion generation apparatus 100 (see FIG. 2) to electrically isolate the source chamber 110 (see FIG. 2) from the extraction chamber 130 (see FIG. 2) and to insulate a high voltage applied to the source chamber 110 from the outside. In order to maintain the quality stability of the ions (10 of FIG. 2) generated by the ion generation apparatus 100 and prevent damage to the ion generation apparatus 100 and the ion implantation facility (1 of FIG. 5) including the same, the bushing 140 is replaced when it is determined that the insulation ability has deteriorated. Since the operation of the ion implantation facility 1 is stopped while the bushing 140 is replaced, the longer the replacement period of the bushing 140 (e.g., as the time between replacing the bushing 140 increases), productivity of the ion implantation process may increase.

The method for diagnosing the bushing according to some embodiments of the present disclosure determines whether the bushing 140 is abnormal before the bushing 140 is mounted on the ion generating apparatus 100. Specifically, in accordance with the present disclosure, the surface resistance of the inner sidewall 140Wa of the bushing 140 is measured to determine whether the bushing 140 is abnormal. Whether the bushing 140 is abnormal before the bushing 140 is mounted on the ion generating apparatus 100 is determined, thereby preventing the bushing 140, which may have a defect or low quality, from being mounted on the ion generating apparatus 100. As the normal bushing 140 is selected and mounted on the ion generating apparatus 100, the replacement period of the bushing 140 may increase. Accordingly, the productivity of the ion implantation process may be improved.

In concluding the detailed description, those skilled in the art will appreciate that many variations and modifications may be made to the preferred embodiments without substantially departing from the principles of the present disclosure. Therefore, the disclosed preferred embodiments of the disclosure are used in a generic and descriptive sense only and not for purposes of limitation.

What is claimed is:

1. A bushing diagnostic system, comprising:
a source chamber configured to receive a process gas to generate ions, and to discharge the generated ions through an outlet of the source chamber;
a power supply for providing a voltage to the source chamber;
an extraction chamber surrounding the outlet of the source chamber;
a bushing surrounding the source chamber and positioned adjacent to the extraction chamber, the bushing formed of an insulating material;
a ground line electrically connected to the bushing;
a sensor installed on the ground line and configured to measure a current flowing from the bushing and through the ground line; and
a diagnostic device in communication with the sensor and configured to analyze a partial discharge type based on the current measured by the sensor, the diagnostic device configured to determine whether the bushing is abnormal based on the analyzed partial discharge type.

2. The bushing diagnostic system of claim 1, wherein the diagnostic device is configured to convert the current measured by the sensor into time series data of a charge amount, and the diagnostic device is configured to analyze the partial discharge type based on the time series data of the charge amount.

3. The bushing diagnostic system of claim 2, wherein the diagnostic device is configured to:
set an analysis period, wherein a length of the analysis period is smaller than a measurement period of the charge amount;
analyze an abnormal period by sliding the analysis period over time, wherein the abnormal period is an analysis period in which a number of times that the charge amount data exceeds a reference value is equal to or greater than a first reference number; and
compare a number of the abnormal periods to a second reference number and analyze the partial discharge type based on the comparison.

4. The bushing diagnostic system of claim 2, wherein the diagnostic device is configured to generate a pattern based on the time series data of the charge amount, and configured to analyze the partial discharge type based on a similarity between the generated pattern and a reference pattern.

5. The bushing diagnostic system of claim 4, wherein the time series data of the charge amount includes (t1, Q1), (t2, Q2), and (t3, Q3), wherein (t1, Q1) is a charge amount Q1 at time t1, (t2, Q2) is a charge amount Q2 at time t2, and (t3, Q3) is a charge amount t3 at time Q3,
wherein the diagnostic device is configured to:
generate difference data based on the time series data of the charge amount, wherein the difference data includes ((Q2−Q1), (Q3−Q2)); and
display the difference data on a Euclidean plane to generate the pattern.

6. The bushing diagnostic system of claim 1, wherein the diagnostic device is configured to determine that the bushing is abnormal based on the analyzed partial discharge type being classified as a surface discharge.

7. The bushing diagnostic system of claim 1, wherein the bushing includes an inner sidewall to which a by-product generated in a process of generating the ions is configured to be attached,
wherein the diagnostic device is configured to determine whether an insulation ability of the bushing is deteriorated due to the by-product being attached to the inner sidewall, based on the current measured by the sensor.

8. The bushing diagnostic system of claim 1, further comprising a first flange connecting the bushing to the source chamber and a second flange connecting the bushing to the extraction chamber,
wherein the ground line is directly connected to the second flange.

9. The bushing diagnostic system of claim 8, further comprising a fastening member fastening the bushing and the second flange to each other, wherein the fastening member is formed of a conductive material.

10. The bushing diagnostic system of claim 1, wherein the bushing includes an inner sidewall and an outer sidewall opposite to each other,
wherein the inner sidewall of the bushing faces the source chamber and includes one or more convex-concave patterns.

11. The bushing diagnostic system of claim 1, wherein the power supply is a high voltage direct current (HVDC) power supply.

12. The bushing diagnostic system of claim 1, wherein the sensor is a high frequency current transformer (HFCT) sensor.

13. A bushing diagnostic system, comprising:
a source chamber configured to receive a process gas to generate ions, and to discharge the generated ions through an outlet of the source chamber;
a power supply for providing a voltage to the source chamber;
an extraction chamber surrounding the outlet of the source chamber;
a first flange connected to the source chamber;
a second flange connected to the extraction chamber;
a bushing positioned between the first flange and the second flange, the bushing surrounding the source chamber and formed of an insulating material;
a ground line connected to the second flange;
a sensor installed on the ground line and configured to measure a current flowing from the bushing and through the ground line;
a diagnostic device in communication with the sensor and configured to convert a current measured by the sensor into time series data of a charge amount, the diagnostic device configured to analyze the time series data of the charge amount, and determine whether the bushing is abnormal based on the analysis.

14. The bushing diagnostic system of claim 13, wherein the diagnostic device is configured to:
set an analysis period, wherein a length of the analysis period is smaller than a measurement period of the charge amount;
analyze an abnormal period by sliding the analysis period over time, wherein the abnormal period is an analysis period in which a number of times that the charge amount data exceeds a reference value is equal to or greater than a first reference number;
compare a number of the abnormal periods to a second reference number;
in response to the number of the abnormal periods being equal to or greater than the second reference number, determine that the bushing is abnormal.

15. The bushing diagnostic system of claim 13, wherein the time series data of the charge amount includes (t1, Q1), (t2, Q2), and (t3, Q3), wherein (t1, Q1) is a charge amount Q1 at time t1, (t2, Q2) is a charge amount Q2 at time t2, and (t3, Q3) is a charge amount t3 at time Q3,
wherein the diagnostic device is configured to:
generate difference data based on the time series data of the charge amount, wherein the difference data includes ((Q2−Q1), (Q3−Q2));
display the difference data on a Euclidean plane to generate a pattern;
determine whether the bushing is abnormal based on a similarity between the generated pattern and a reference pattern.

16. The bushing diagnostic system of claim 13, wherein the bushing includes an inner sidewall to which a by-product generated in a process of generating the ions is configured to be attached,
wherein the diagnostic device is configured to analyze the time series data of the charge amount and determine whether an insulation ability of the bushing is deteriorated due to the by-product being attached to the inner sidewall, based on the analysis.

17. The bushing diagnostic system of claim 13, further comprising: a fastening member fastening the bushing and the second flange to each other, wherein the fastening member is formed of a conductive material.

18. The bushing diagnostic system of claim 13, wherein the power supply is a high voltage direct current (HVDC) power supply.

19. A bushing diagnostic system, comprising:
an ion generating apparatus including: a source chamber configured to generate ions and discharge the ions through an outlet of the source chamber; a power supply configured to provide a voltage to the source chamber; an extraction chamber surrounding the outlet of the source chamber; a bushing surrounding the source chamber and positioned adjacent to the extraction chamber, the bushing formed of an insulating material; a ground line electrically connected to the bushing; and a sensor installed on the ground line and configured to measure a current flowing from the bushing and through the ground line;
a process chamber in which a wafer is positioned, wherein the ions discharged from the ion generating apparatus are configured to be injected into the wafer;
a beam line installed between the ion generating apparatus and the process chamber, wherein the beam line is configured to receive the ions from the ion generating apparatus, adjust the ions, and provide the adjusted ions to the process chamber; and
a diagnostic device configured to analyze a partial discharge type of the bushing based on a current measured by the sensor, the diagnostic device configured to determine whether the bushing is abnormal based on the analyzed partial discharge type being classified as a surface discharge.

20. The bushing diagnostic system of claim 19, wherein the diagnostic device is configured to convert the current measured by the sensor into time series data of a charge amount, and the diagnostic device is configured to analyze the partial discharge type based on the time series data of the charge amount.
